(19) United States
(12) Patent Application Publication
(10) Pub. No.: US 2007/0163946 A1
(43) Pub. Date: Jul. 19, 2007

(54) Reversible element guide

(75) Inventors: Nishaj Attassery, Schaumburg, IL (US); L. Steven Cline, Fayetteville, NC (US)

Correspondence Address: CROWELL & MORING LLP;INTELLECTUAL PROPERTY GROUP, P.O. BOX 14300, WASHINGTON, DC, 20044-4300, US

(73) Assignee: Arvin Technologies, Inc.

(21) Appl. No.: 11/334,266

(22) Filed: Jan. 18, 2006

(51) Int. Cl. B01D 27/00

(52) U.S. Cl. 210/450; 210/456

(57) ABSTRACT

A filter uses a reversible element guide. The filter includes a housing that provides a cavity. A filter element assembly is arranged in the cavity and includes an end cap supporting the filter media. An element guide is arranged between the end cap and the housing. The element guide includes a first set of tabs engaging the end cap and a second set of tabs engaging the housing. The number of tabs in each set are equal to one another so that they will exert the same biasing force when installed in either orientation. The tabs extend away from a base at a height that is the same on each side of the base.

### BACKGROUND OF THE INVENTION

This invention relates to an element guide for a filter, such as an oil filter, which is reversible.

Filters, such as oil filters, include a housing that provides a cavity. A filter element assembly is arranged in the cavity for filtering debris from the fluid. The filter element assembly must be sealed against various components within the filter to ensure that the fluid is directed through the filter element assembly under desired conditions. An element guide is arranged within the cavity to apply a biasing force on the filter element assembly to ensure proper sealing of the filter element assembly.

Typically, the element guide is a stamped piece of metal having opposing legs that are arranged on a same side of the element guide. The side with the legs engages the housing and an opposite side engages an end cap of the filter element assembly. The element guide must be oriented properly within the filter during assembly; otherwise, an insufficient amount of biasing force will be exerted against the filter element assembly. Improperly oriented element guides result in less than desired sealing of the filter element assembly or even a loose, non-functional element guide. As a result, unfiltered fluid will flow past the filter element assembly.

Costly measures have been employed to ensure that they element guide is installed in the correct orientation. For example, expensive machinery is used to properly orient the element guide prior to insertion into the housing. Additional machinery and/or workers may also check for proper orientation of the element guide once it has been installed into the housing. Finally, random checks of fully assembled filters are done to verify proper sealing of the filter element assembly.

What is needed is an element guide that can be installed in any orientation to simplify assembly and reduce cost.

### SUMMARY OF THE INVENTION

A filter according to the present invention uses a reversible element guide. The filter includes a housing that provides a cavity. A filter element assembly is arranged in the cavity and includes an end cap supporting a filter media. An element guide is arranged between the end cap and the housing. The element guide includes a first set of tabs engaging the end cap and a second set of tabs engaging the housing. The tabs extend away from a base. In one example, the number of tabs in each set are equal to one another so that they will exert the same biasing force when installed in either orientation. In the same example, the tabs extend from the base to a height that is the same for each set of the first and second sets of tabs. Accordingly, the element guide can be installed in any orientation and still provide the same biasing force to the filter element assembly.

These and other features of the present invention can be best understood from the following specification and drawings, the following of which is a brief description.

### BRIEF DESCRIPTION OF THE DRAWINGS

FIG. 1A is a perspective view of one example element guide.

FIG. 1B is a top elevational view of the element guide shown in FIG. 1A.

FIG. 1C is a cross-sectional view of a portion of a filter with the element guide of FIG. 1A installed.

FIG. 2A is a perspective view of another example element guide.

FIG. 2B is a top elevational view of the element guide shown in FIG. 2A.

FIG. 2C is a cross-sectional view of a portion of a filter with the element guide of FIG. 2A installed.

FIG. 3A is a perspective view of another example element guide.

FIG. 3B is a top elevational view of the element guide shown in FIG. 3A.

FIG. 3C is a cross-sectional view of a portion of a filter with the element guide of FIG. 3A installed.

### DETAILED DESCRIPTION OF THE PREFERRED EMBODIMENT

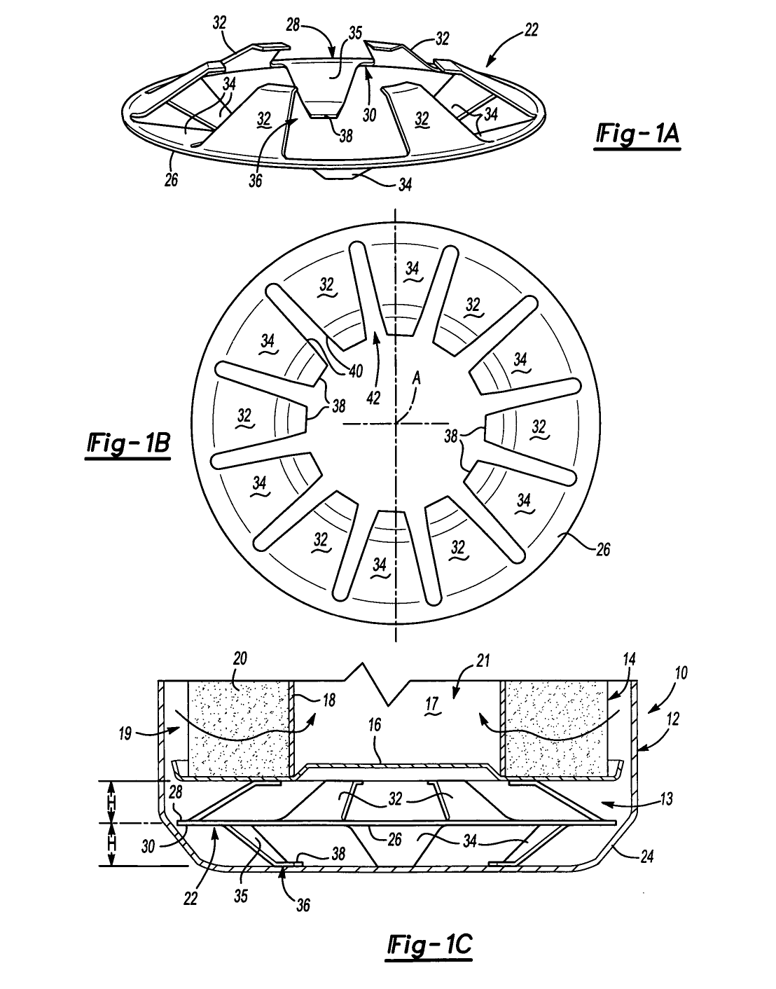

An example element guide 22 according to the present invention is shown in FIGS. 1A-1C. The element guide 22 is constructed from a flexible material. Typically a metal is used. Due to the flexible material, the element guide 22 applies a biasing force when compressed. In one example, the element guide 22 is formed of a stamped metal.

Referring to FIG. 1C, a filter 10 includes a housing 12. A filter element assembly 14 is arranged in a cavity 13 of the housing. The filter element assembly 14 includes an end cap 16 supporting a filter media 20. A center tube 18 is arranged in a central aperture 17 provided by the filter media 20. The filter element assembly 14 is sealed within the housing 12, as known in art. The filter element assembly 14 separates an inlet side 19 from an outlet side 21. Fluid within the filter 10 flows through the filter media 20 to remove debris from the fluid.

The element guide 22 biases the filter element assembly 14 against components within the filter 10 to seal the filter element assembly 14, thereby ensuring that the fluid flows through the filter media 20 under desired conditions.

The element guide 22 includes a base 26 having first and second sides 28 and 30 that are arranged opposite from one another. First and second sets of tabs 32 and 34 respectively extend from the first and second sides 28 and 30. In the examples shown, at least two tabs are provided in each of the first and second sets of tabs 32 and 34.

Referring to FIGS. 1A and 1B, the element guide 22 includes six tabs on each of the first and second sides 28 and 30. The base 26 provides an outer peripheral portion from which the first and second sets of tabs 32 and 34 extend radially inwardly toward a central axis A. The tabs provide tapered legs 35 terminating in an end portion 36. In the example shown in FIGS. 1A and 1B, the end portion 36 is provided by a flat surface, which engages flat features of the housing 12 and end cap 16. Edges 40 of the tabs are spaced from one another to provide gaps 42 permitting fluid to flow past the element guide 22.

Each of the first and second sets of tabs 32 and 34 extend from the base 26 a height H that are all approximately equal. Using the same number of tabs extending approximately the same height better ensures that the same biasing force is exerted on the filter element assembly 14 regardless of the orientation of the element guide 22. That is, since the element guide is symmetrical when oriented in either direction, the same biasing force will be exerted on the filter element assembly 14. A plane of symmetry is indicated by the dashed line in the Figures.

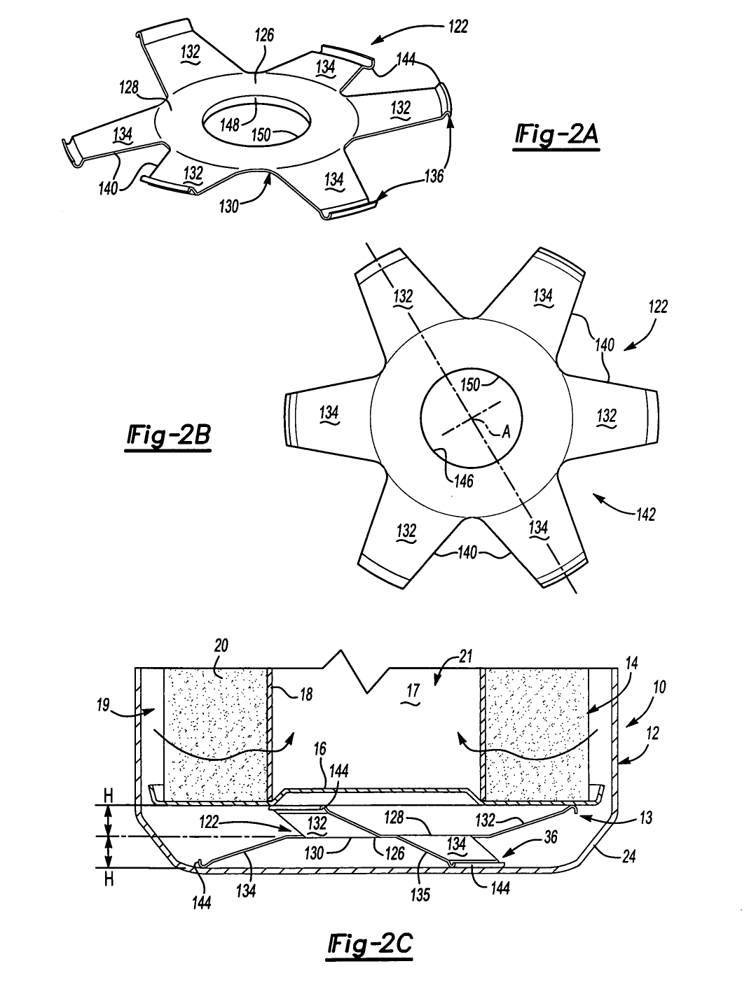

Referring to FIGS. 2A-2C, in a second embodiment 122 the first and second sets of tabs 132 and 134 extend radially outwardly from the base 126. Each of the first and second sets of tabs 132 and 134 include three tabs. The end portions 136 of the tabs on the second side 130 engage an angled portion of the housing 12. As a result, it may be desirable to provide a curve surface 144 on the end portions 136 so that an outer edge of the tab does not dig into the angled wall when compressed, which could affect the biasing force.

The base 126 includes an inner periphery 146 providing a hole 150. A lip or flange 148 is provided at the inner periphery 146 to increase the rigidity of the base 126.

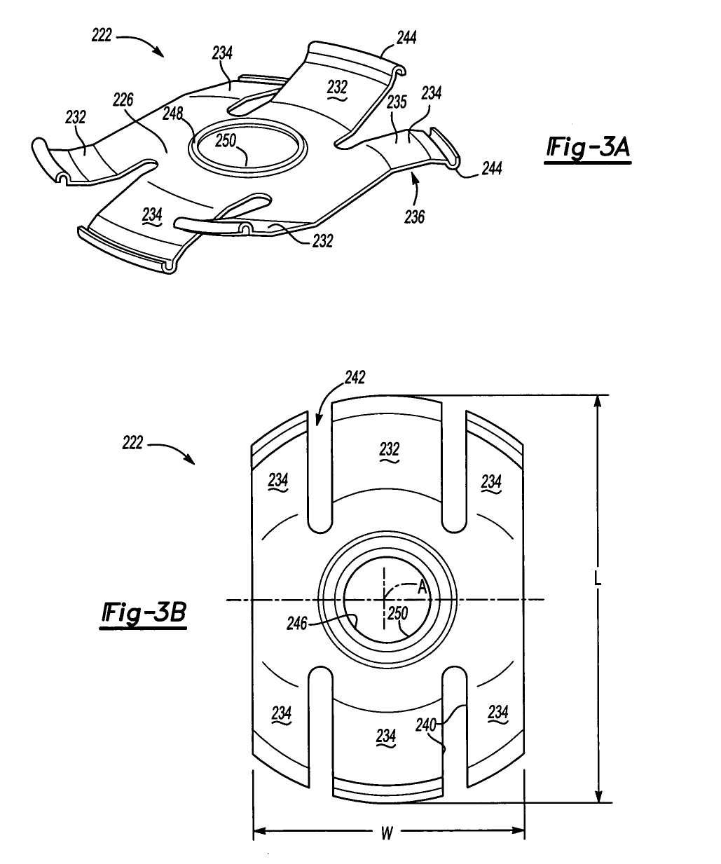

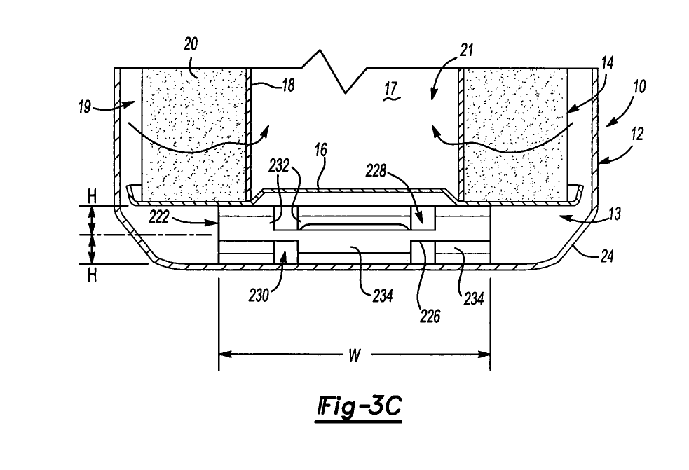

Another example element guide 222 is shown in FIGS. 3A-3C. The element guide 222 has a width W that is less than a length L. The example arrangement illustrates a wider tab centrally located with narrower tabs on either side of the wider tab. The end portion 236 includes curved surfaces 244. The inner periphery 246 of the base 226 includes a lip that provides the hole 250.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A filter comprising:
a housing providing a cavity;
a filter element assembly arranged in the cavity and including an end cap supporting a filter media; and
an element guide arranged between the end cap and the housing, the element guide including a first set of tabs engaging the end cap and a second set of tabs engaging the housing.

2. The filter according to claim 1, wherein the element guide includes a base having first and second sides opposite one another, the first and second set of tabs respectively extending from the first and second sides and away from one another.

3. The filter according to claim 2, wherein the base provides a peripheral portion and the first and second sets of tabs extend radially inwardly from the peripheral portion toward an axis of the element guide.

4. The filter according to claim 2, wherein the first and second sets of tabs extend to curved end portions, the curved end portions of one of the first and second sets of tabs engaging the housing.

5. The filter according to claim 1, wherein the first set of tabs provides a biasing force approximately equal to a biasing force provided by the second set of tabs.

6. The filter according to claim 5, wherein the first and second sets of tabs have a number of tabs equal to one another.

7. The filter according to claim 1, wherein the element guide includes generally symmetrical halves.

8. An element guide for a filter comprising:
a base having first and second sides opposite from one another; and
first and second sets of tabs respectively extending away from the first and second sides.

9. The element guide according to claim 8, wherein the base provides a peripheral portion with first and second sets of tabs extending from the peripheral portion.

10. The element guide according to claim 9, wherein the first and second sets of tabs extend radially inwardly toward an axis of the peripheral portion.

11. The element guide according to claim 9, wherein the first and second sets of tabs extend outwardly away from the peripheral portion.

12. The element guide according to claim 11, wherein the peripheral portion includes an annular flange providing a hole.

13. The element guide according to claim 11, wherein the first and second sets of tabs extend to curved end portions.

14. The element guide according to claim 8, wherein the tabs in each of the first and second sets of tabs are circumferentially spaced from one another.

15. The element guide according to claim 8, wherein each of the first and second sets of tabs extend an approximately equal height from the base.

16. The element guide according to claim 8, wherein the first and second sets of tabs have a number of tabs equal to one another.

17. The element guide according to claim 8, wherein the tabs of the first and second sets of tabs provide tapered legs terminating in end portions having a flat surface angled relative to the tapered leg.
